(19) United States
(12) Patent Application Publication
(10) Pub. No.: US 2023/0328099 A1
(43) Pub. Date: Oct. 12, 2023

(54) CONTAINERIZED EXECUTION OF UNKNOWN FILES IN A DISTRIBUTED MALWARE DETECTION SYSTEM

(71) Applicant: VMware,Inc., Palo Alto, CA (US)

(72) Inventors: Rayanagouda Bheemanagouda PATIL, Pune (IN); Kedar Bhalchandra CHAUDHARI, Pune (IN); Shivali SHARMA, Pune (IN); Laxmikant Vithal GUNDA, San Jose, CA (US); Sriram GOPALAKRISHNAN, Pune (IN)

(21) Appl. No.: 17/658,588

(22) Filed: Apr. 8, 2022

(51) Int. Cl. H04L 9/40

(52) U.S. Cl. CPC H04L 63/145; H04L 63/1416; H04L 63/1425

(57) ABSTRACT

A method for opening unknown files in a malware detection system, is provided. The method generally includes receiving a request to open a file classified as an unknown file, opening the file in a container, collecting at least one of a log of events carried out by the file or observed behavior traces of the file while open in the container, transmitting, to a file analyzer, at least one of the file, the log of events, or the behavior traces for static analysis, determining, a final verdict for the file, based on at least one of the file, the log of events, or the behavior traces, wherein the final verdict for the file is based on the static analysis or dynamic analysis of the file, and taking one or more actions based on a policy configured for the first endpoint and the final verdict.

### BACKGROUND

Today's enterprises rely on defense-in-depth mechanisms (e.g., multiple layers of security defense controls used to provide redundancy in the event a security control fails) to protect endpoint computing devices from malware infection. Malware is malicious software that, for example, disrupts network operations and gathers sensitive information on behalf of an unauthorized third party. Targeted malware may employ sophisticated methodology and embed in the target's infrastructure to carry out undetected malicious activities. In particular, once malware gains access to an endpoint, the malware may attempt to control the device and use lateral movement mechanisms to spread to other endpoints and critical assets of an enterprise.

Anti-malware solutions are employed to detect and prevent malware from infiltrating such endpoint computing devices in a system using various techniques, such as, sandboxing of malware samples, signature based detection of known malwares, and blocking of malwares from spreading in the environment.

Sandboxing is a software management strategy used to identify zero day malware threats (e.g., threats not previously known about or anticipated). In particular, sandboxing proactively detects malware by executing files in a safe and isolated environment to observe that file's behavior and output activity. As used herein, a file that is analyzed may include a file opened by another application, an executable application or code, and/or the like. Traditional security measures are reactive and based on signature detection—which works by looking for patterns identified in known instances of malware. Because traditional security measures detect only previously identified threats, sandboxes add another layer of security.

While sandboxing techniques are used for dynamic malware analysis, static malware analysis involves analyzing and/or scanning of files to determine any malicious behavior. Performing static analysis is a way to detect malicious code or infections within the file. In particular, static analysis may involve parsing data, extracting patterns, attributes and artifacts, and flagging anomalies.

Static malware analysis and/or dynamic malware analysis (e.g., with the use of sandboxing techniques) of files may be used to derive and return a verdict, such as BENIGN, MALICIOUS, etc., for the file. For example, where the static and/or dynamic analysis finds that the executed file modifies system files and/or infects the system in any way, those issues may not spread to other areas given the isolated nature of the sandbox environment. Accordingly, a verdict of MALICIOUS may be assigned to the file indicating the sample is malware and poses a security threat. On the other hand, where the static and/or dynamic analysis finds that the executed file is safe and does not exhibit malicious behavior, a verdict of BENIGN may be assigned. Such derived verdicts may be used to take appropriate policy action, for example, to enable blocking or access to the files by endpoints in the system.

In some cases, while performing analyses on an unknown file to ascertain a verdict for the file, one strategy includes quarantining the file until analysis is complete and a verdict for the file has been returned. In other words, the file may be held in isolation on an endpoint and not be permitted to execute until the file is determined to be safe or unsafe for execution. While static and dynamic malware analyses are useful tools that can effectively detect unknown or zero-day threats, such analyses are time-consuming activities (and in some cases, are computationally expensive). Accordingly, in this case, the file may be quarantined for an amount of time which adversely affects the experience of a user attempting to access and/or execute the file. For example, a user attempting to open a file having an unknown verdict may need to wait an undesirable about of time, for example, until a verdict for the file is published, prior to being able to open the file. This approach may be referred to as the “deny all unknowns” approach.

Accordingly, in some cases as an alternative to quarantining the file, the unknown file may be opened (e.g., allowed to execute, accessed, etc.) while static and/or dynamic malware analyses are asynchronously being performed to ascertain a verdict for the file. This approach enhances user experience by not requiring a verdict prior to access and/or execution of the file. However, in cases where the file is, in fact, malware, this approach increases the risk of attack on the endpoint, as well as, increases the likelihood of a malicious file spreading and compromising other endpoints in the environment. This approach may be referred to as the “first patient dies” approach.

Further, by the time a verdict for the file is returned indicating that the file is MALICIOUS, the file may have compromised multiple endpoints in the environment. At this point, it may be unclear which endpoints in the environment the MALICIOUS file has compromised and/or where the MALICIOUS file has spread. Accordingly, clean-up of the malware and its traces may become tedious. Further, it may be unclear whether the clean-up was a success or whether the malware still exists in the environment.

In other words, neither approach provides a perfect solution to identifying zero day malware threats. For example, disadvantages of the “first patient dies” approach and the “deny all unknowns” approach include (1) the denial of services which negatively impacts user experience and/or developer productivity as well as (2) an increase to the threat surface of a system, respectively.

Further, malware variants are becoming increasingly sophisticated and evasive, thereby making identifying and stopping malware infections more challenging. For example, a new variant of malware which exists today includes sandbox-evading malware. Sandbox-evading malware is a type of malware that can recognize if it's inside a sandbox or another isolated environment used for analysis of the file. If the malware detects a sandbox or another isolated environment for analysis of the file, the malware will not execute its true malicious behavior and, therefore, appears to be another BENIGN file. Instead, these malware infections may wait until they're outside of the controlled environment to execute their MALICIOUS code. Accordingly, the ability of the malware to hide its MALICIOUS functionality decreases the ability of existing solutions to detect the malware during analysis. Unfortunately though, while malware is becoming more sophisticated, the pressure to identify MALICIOUS infections in a timely manner continues to increase. In particular, sandbox providers are under continuous pressure to provide a verdict for an unknown file as soon as possible. The combination of less time and more sophisticated malware, in some cases, leads to less meticulous analysis and accordingly malware getting missed during analysis.

Lastly, in conventional malware detections systems, dynamic analysis of files (e.g., sandboxing) is often performed outside of a network; however, some customers are sensitive to sending their data outside of the network for analysis. If a file is not permitted to be transmitted outside of the environment, often times, dynamic analysis of the file may not be performed to detect whether the file is MALICIOUS, or not, based on execution of the file's code. Instead, a verdict for a file may only rely on static analysis techniques for classification of the file, although dynamic analysis may provide a more thorough analysis into the behavior of the file for more accurate classification.

It should be noted that the information included in the Background section herein is simply meant to provide a reference for the discussion of certain embodiments in the Detailed Description. None of the information included in this Background should be considered as an admission of prior art.

### BRIEF DESCRIPTION OF THE DRAWINGS

FIG. 1 depicts example physical and virtual components in a networking environment in which embodiments of the present disclosure may be implemented.

FIGS. 2A, 2B, and 2C illustrate an example workflow for evaluating unknown files in a distributed malware detection system, according to an example embodiment of the present application.

### DETAILED DESCRIPTION

Aspects of the present disclosure present techniques for opening (e.g., executing, accessing, etc.) an unknown file in an isolated environment, such as a container, while static and/or dynamic malware analysis(es) are asynchronously being performed to ascertain a verdict for the file.

As mentioned, an unknown verdict may be an initial verdict for a file which has not yet been analyzed by a malware detection system. In certain aspects, a malware detection system is a distributed malware detection system, as described herein, which involves decentralized architecture where resources on two or more endpoints (e.g., a server, a host, etc.) are leveraged to isolate and examine unknown files and produce a verdict regarding the safety of the file. A file may be “unknown” when the file has not previously been identified as BENIGN or MALICIOUS, such as based on a previous verification.

According to aspects described herein, while an unknown file is being analyzed, access and/or execution of the file may be permitted in a container to ensure optimal user experience, as well as developer productivity. Containers are lightweight, standalone, executable packages that enable files to run concurrently on a single instance of an operating system (OS). Although sandboxes and containers both provide an isolated environment for the execution of files, the isolated environment provided by a container may not be intended for malware analysis, as opposed to a sandbox. In particular, a user may use the file executing in the container on the machine, similar to as though the file were executing directly on the machine. Containers may run on a machine, such as a physical computing device directly, or on a virtual machine (VM) or other virtual computing instance (VCI). Though certain aspects are described with respect to permitting execution of a file in a container running on a VM, it should be noted that the techniques discussed herein may similarly be used for other suitable VCIs.

Execution of an unknown file in a container prior to categorizing the file as “safe” (e.g., BENIGN) or “unsafe” (e.g., MALICIOUS), may allow for the immediate execution of the unknown file while mitigating the security risk imposed by the file, should the file contain malware. Accordingly, aspects described herein may help to maintain the balance between security and user experience, as well as developer productivity (e.g., as opposed to quarantining the file or allowing the file to execute with privileges which may harm the system, as used in conventional techniques described previously herein).

For example, containers are live, running instances of container images which contain executable application source code, as well as all the tools, libraries, and dependencies that the application source code needs to run as a container. Container images are stored as series of read-only layers. When a container is started, a read-write layer is added on top of the read-only layer. If the running container modifies an existing file, the file is copied out of the underlying read-only layer and into the top-most read-write layer where the changes are applied. The version in the read-write layer hides the underlying file, but does not destroy it. When a container is deleted, relaunching the image will start a fresh container without any of the changes made in the previously running container; thus, any previous changes are lost. Accordingly, changes to data which are made by files executing inside a container may not be persisted, and more specifically, may not affect data of a machine where the container is running. For this reason, risks of MALICIOUS files altering and/or accessing data in the system may be prevented.

Further, containers provide a degree of separation as they are isolated from other components, such as other containers, VMs, VCIs, endpoints, etc. running in the environment. This isolation may allow for the execution of a potentially MALICIOUS file without the spread of the MALICIOUS file to other components. For example, a policy may be set such that lateral movement mechanisms, for example, used to spread to other endpoints and critical assets of the system, are prohibited while executing inside a container.

Because of each of these safeguards provided when executing an unknown file in a container, the pressure to produce a verdict for the file may be lessened. Given risks of potentially MALICIOUS files are mitigated while opening the file inside a container, static and/or dynamic analysis(es) may be able to more thoroughly inspect for traces of malware such that a more accurate verdict may be produced for the file. This may help to prevent false-negative scenarios where a file is determined to be BENIGN and allowed to run outside of a container, when in fact the file contains MALICIOUS code which proves to be harmful to the overall integrity of the system.

Lastly, opening of an unknown file inside a container may allow for the collection of an event log for the file. An event log is a file of events that are logged during execution of the file. Logged events included in the event log may include operations that have been carried out, or unsuccessfully carried out, by the file, such as object access, object deletion, login attempts, policy changes, etc. Execution of the file inside the container may also allow for behavior of the file to be monitored and recorded (e.g., referred to herein as behavior traces). According to certain aspects described herein, one, or both, of the event log or behavior traces collected for the file may provide an additional input to static and/or dynamic analysis(es) performed on the file, such that a more accurate verdict determination may be made. Specifically, as mentioned previously, when placed in a sandboxing environment, sandbox-evading malware may be designed to detect that the malware is running inside the sandbox and refrain from executing its true MALICIOUS behavior to trick the system into classifying the file as BENIGN. However, by placing the MALICIOUS file in the container for execution, the file may execute as normal such that the MALICIOUS behavior of the file may not be hidden. Such MALICIOUS behavior of the file may be captured in an event log and behavior traces for the file and used as supplemental information in static and/or dynamic analysis(es) performed on the file. Further, in cases where a policy is set which does not permit the sending of the file itself outside of the system for example, for external dynamic analysis, (e.g., some customers are sensitive to sending files to outside sources for analysis), collection of the event logs and/or behavior traces associated with the file may be used, as an alternative, for such dynamic analysis.

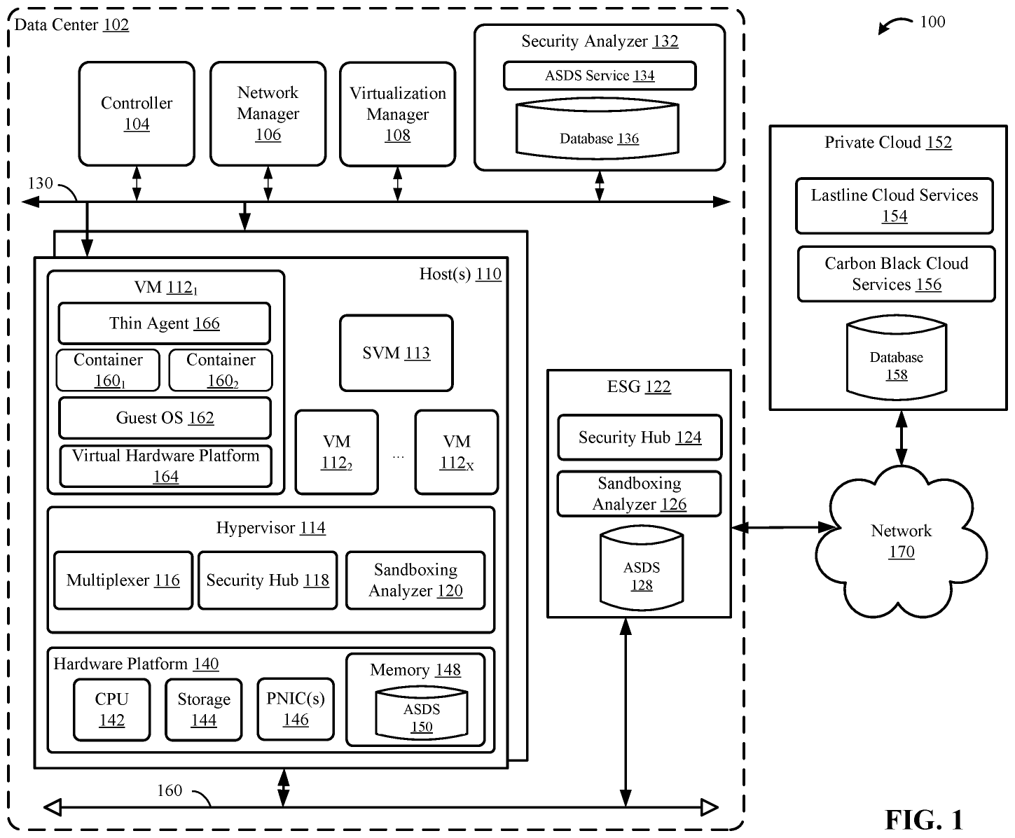

FIG. 1 depicts example physical and virtual network components in a networking environment 100 in which embodiments of the present disclosure may be implemented. As shown in FIG. 1, networking environment 100 may be distributed across a hybrid cloud. A hybrid cloud is a type of cloud computing that combines on-premises infrastructure, e.g., a private cloud 152 comprising one or more physical computing devices (e.g., running one or more virtual computing instances (VCIs)) on which the processes shown run, with a public cloud, or data center 102, comprising one or more physical computing devices (e.g., running one or more VCIs) on which the processes shown run. Hybrid clouds allow data and applications to move between the two environments. Many organizations choose a hybrid cloud approach due to organization imperatives such as meeting regulatory and data sovereignty requirements, taking full advantage of on-premises technology investment, or addressing low latency issues.

Data center 102 and private cloud 152 may communicate via a network 170. Network 170 may be an external network. Network 170 may be a layer 3 (L3) physical network. Network 170 may be a public network, a wide area network (WAN) such as the Internet, a direct link, a local area network (LAN), another type of network, or a combination of these.

Data center 102 includes one or more hosts 110, an edge services gateway (ESG) 122, a management network 180, a data network 160, a controller 104, a network manager 106, a virtualization manager 108, and a security analyzer 132. Data network 160 and management network 180 may be implemented as separate physical networks or as separate virtual local area networks (VLANs) on the same physical network.

Host(s) 110 may be communicatively connected to both data network 160 and management network 180. Data network 160 and management network 180 are also referred to as physical or “underlay” networks, and may be separate physical networks or the same physical network as discussed. As used herein, the term “underlay” may be synonymous with “physical” and refers to physical components of networking environment 100. As used herein, the term “overlay” may be used synonymously with “logical” and refers to the logical network implemented at least partially within networking environment 100.

Each of hosts 110 may be constructed on a server grade hardware platform 140, such as an x86 architecture platform. Hosts 110 may be geographically co-located servers on the same rack or on different racks. Hardware platform 140 of a host 110 may include components of a computing device such as one or more processors (CPUs) 142, storage 144, one or more network interfaces (e.g., physical network interface cards (PNICs) 146), system memory 148, and other components (not shown). A CPU 142 is configured to execute instructions, for example, executable instructions that perform one or more operations described herein and that may be stored in the memory and storage system. The network interface(s) enable host 110 to communicate with other devices via a physical network, such as management network 180 and data network 160.

Each host 110 is configured to provide a virtualization layer, also referred to as a hypervisor 130. Hypervisors abstract processor, memory, storage, and networking physical resources of hardware platform 140 into a number of VCIs or VMs 112(1) . . . (x) (collectively referred to as VMs 112) on hosts 110. As shown, multiple VMs 112 may run concurrently on the same host 110.

Each VM 112 implements a virtual hardware platform 164 that supports the installation of a guest OS 162 which is capable of executing one or more applications. Guest OS 162 may be a standard, commodity operating system. Examples of a guest OS include Microsoft Windows, Linux, and the like. In some examples, guest OS 162 includes a native file system layer, for example, either a New Technology File System (NTFS) or an ext3 type file system layer. This file system layer interfaces with virtual hardware platform 164 to access, from the perspective of guest OS 162, a data storage host bus adapter (HBA), which in reality, is a virtual HBA implemented by virtual hardware platform 164 that provides the appearance of disk storage support to enable execution of guest OS 162 transparent to the virtualization of the system hardware. Although, from the perspective of guest OS 162, file system calls initiated by guest OS 162 to implement file system-related data transfer and control operations appear to be routed to virtual disks for final execution, in reality, such calls are processed and passed through the virtual HBA to hypervisor 114. In particular, the data transfer and control operations may be passed through various layers of hypervisor 114 to true hardware HBAs or physical network interface cards (PNICs) 146 that connect to storage 144.

In certain aspects, each VM 112 includes a container engine installed therein and running as a guest application under control of guest OS 162. Specifically, a container engine is a process that enables the deployment and management of virtual instances (referred to interchangeably herein as “containers”) by providing a layer of OS-level virtualization on guest OS 162 within VM 112. Containers 1601 to 160y (collectively referred to as containers 160 and individually referred to as container 160) are software instances that enable virtualization at the OS level. That is, with containerization, the kernel of an OS that manages host 110 is configured to provide multiple isolated user space instances, referred to as containers. Containers 160 appear as unique servers from the standpoint of an end user that communicates with each of containers 160. However, from the standpoint of the OS that manages host 110 on which the containers execute, the containers are user processes that are scheduled and dispatched by the OS. Containers 160 encapsulate an application as a single executable package of software that bundles application code together with all of the related configuration files, libraries, and dependencies required for it to run.

According to certain aspects described herein, containers 160 may be used to open unknown files prior to categorizing the file as “safe” (e.g., BENIGN) or “unsafe” (e.g., MALICIOUS). This may allow for immediate execution of the unknown file while mitigating the security risk imposed by the file, should the file contain malware.

In certain aspects, the processor, memory, storage, and networking physical resources of hardware platform 140 are abstracted into a service VM (SVM) 113. SVM 113 is a VM that is also executed on host 110 and is used for providing a service to at least a subset of VMs 112 (e.g., guest VMs). Each host 110 may include an SVM 113. As described in more detail below, SVM 113 may be configured to protect VMs 112 running on host 110 by taking appropriate action in accordance with one or more policies. As described in more detail below, policies may be configured at hosts 110 and ESG 122 to indicate what action is to be taken when a file is determined to be MALICIOUS.

Each hypervisor 130 may run in conjunction with an operating system (OS) in its respective host 110. In some embodiments, hypervisors can be installed as system level software directly on hardware platforms of its respective host 110 (e.g., referred to as “bare metal” installation) and be conceptually interposed between the physical hardware and the guest OSs executing in the VMs 112. Though certain aspects are described herein with respect to VMs 112 running on host machines 110, it should be understood that such aspects are similarly applicable to physical machines, like host machines 110, without the use of virtualization.

ESG 122 is configured to operate as a gateway device that provides components in data center 102 with connectivity to an external network, such as network 170. ESG 122 may be addressable using addressing of the physical underlay network (e.g., data network 160). ESG 122 may manage external public IP addresses for VMs 112. ESG 122 may include a router (e.g., a virtual router and/or a virtual switch) that routes traffic incoming to and outgoing from data center 102. ESG 122 also provides other networking services, such as firewalls, network address translation (NAT), dynamic host configuration protocol (DHCP), and load balancing. ESG 122 may be referred to as a nested transport node, for example, as the ESG VM 122 does encapsulation and decapsulation. ESG 122 may be a stripped down version of a Linux transport node, with the hypervisor module removed, tuned for fast routing. The term, “transport node” refers to a virtual or physical computing device that is capable of performing packet encapsulation/decapsulation for communicating overlay traffic on an underlay network.

While ESG 122 is illustrated in FIG. 1 as a component outside of host 110, in some embodiments, ESG 122 may be situated on host 110 and provide networking services, such as firewalls, NAT, DHCP, and load balancing services as an SVM.

In certain embodiments, a security hub, a static analyzer, and an advance signature distribution service (ASDS) cache may be implemented on one or more hosts 110 and/or ESG 122 for the purpose of detecting malware and other security threats in data center 102.

In particular, a static analyzer may be implemented in data center 102 to perform static analysis of files on each of hosts 110 and/or ESG 122. Such files may be analyzed, for example, when downloaded to a host 110 or ESG 122, when added to a host 110 or ESG 122, before execution on a host 110 or ESG 122, and/or the like. Static analysis is performed for quick scanning of files to determine any malicious behavior. Performing static analysis is a way to detect malicious code or infections within the file.

The static analyzer implemented in data center 102 may run in isolated user spaces on multiple hosts 110 and/or ESGs 122, the isolated user spaces generally referred to as containers. Each container is an executable package of software running on top of a host 110 OS or ESG 122. In certain aspects, each host 110 and/or ESG 122 in data center 102 and/or private cloud 152 is used to run a static analyzer in a container. In certain aspects, a subset of hosts 110 and/or ESGs 122 in data center 102 and/or private cloud 152 is used to run a static analyzer in a container. In certain aspects, the static analyzer is implemented in a single container on a given host 110 and/or ESG 122. In certain aspects, the static analyzer is implemented on multiple containers on a given host 110 and/or ESG 122 In other words, one or more containers per endpoint (e.g., host 110 and/or ESG 122) are used to perform static analysis as a distributed application. Thus, distributed static analysis may be performed by the example implementation illustrated in FIG. 1. As shown in FIG. 1, ESG 122 may include static analyzer 126, and hypervisor 130 of host 110 may include static analyzer 120. While static analyzer 120 is implemented as a component on hypervisor 130, in some other embodiments, static analyzer 120 may be implemented in a VM such as SVM 113 on host 110, or on an OS of host 110.

To execute such static analysis on each host 110 where static analyzer 120 is running, a thin agent 166 (also referred to as a “guest introspection thin agent”), a multiplexer 116, and a security hub 118 are implemented. More specifically, thin agent 166 may be implemented as a component on each VM 112, while multiplexer 116 and security hub 118 may be implemented as components on hypervisor 130 of host 110. According to certain aspects described herein, thin agent 166 running within a VM 112 intercepts files, processes, network events, etc. on VM 112 and provides these files, processes, network events, etc. to multiplexer 116. For example, thin agent 166 may register with a guest OS running on VM 112 to receive information about such events from the guest OS. Multiplexer 116 then provides such information to security hub 118. Security hub 118 may be configured to retrieve verdicts for known files on host 110. A known file may refer to a file for which a verdict is known, such as through a previous inspection or sandboxing. Security hub 118 may retrieve verdicts from ASDS cache 150 stored in physical memory (e.g., random access memory (RAM)) configured within host 110. ASDS cache 150 acts as small, fast memory that store files hashes for recently accessed and inspected files and their associated verdicts. Security hub 118 may use ASDS cache 150 to retrieve verdicts for previously inspected files without accessing database 136 stored on security analyzer 132, which is described in more detail below. Accordingly, data requests satisfied by the cache are executed with less latency as the latency associated with accessing the database 136 is avoided.

Alternatively, to execute such static analysis on ESG 122 where static analyzer 126 is running, a plugin (not shown) (e.g., a software component configured to perform particular function(s)) and a security hub 124 are implemented. More specifically, the plugin and security hub 124 may be implemented on ESG 122. According to certain aspects described herein, a plugin may intercept network packets at ESG 122 and provide these network packets to security hub 124. Security hub 124 may be configured to retrieve verdicts for known files on ESG 122. A known file may refer to a file for which a verdict is known, such as through a previous inspection or analysis. Security hub 124 may retrieve verdicts from ASDS cache 128 stored on ESG 122.

According to certain aspects described herein, security hubs 118, 124 may also be configured to select files on each of hosts 110 and ESG 122, respectively, for analysis. For example, security hub 124 implemented on ESG 122 may interact with a network intrusion detection and prevention system (IDPS) (e.g., used to monitor network activities for malicious activity) to determine which files are to be analyzed. Similarly, security hub 118 implemented on hypervisor 130 of host 110 may interact with VMs 112 to determine which files are to be analyzed. Security hubs 118, 124 may trigger the static analysis of such files.

Data center 102 includes a management plane and a control plane. The management plane and control plane each may be implemented as single entities (e.g., applications running on a physical or virtual compute instance), or as distributed or clustered applications or components. In alternative embodiments, a combined manager/controller application, server cluster, or distributed application, may implement both management and control functions. In the embodiment shown, network manager 106 at least in part implements the management plane and controller 104 at least in part implements the control plane

The control plane determines the logical overlay network topology and maintains information about network entities such as logical switches, logical routers, and endpoints, etc. The logical topology information is translated by the control plane into network configuration data that is then communicated to network elements of host(s) 110. Controller 104 generally represents a control plane that manages configuration of VMs 112 within data center 102. Controller 104 may be one of multiple controllers executing on various hosts in the data center that together implement the functions of the control plane in a distributed manner. Controller 104 may be a computer program that resides and executes in a central server in the data center or, alternatively, controller 104 may run as a virtual appliance (e.g., a VM) in one of hosts 110. Although shown as a single unit, it should be understood that controller 104 may be implemented as a distributed or clustered system. That is, controller 104 may include multiple servers or virtual computing instances that implement controller functions. It is also possible for controller 104 and network manager 106 to be combined into a single controller/manager. Controller 104 collects and distributes information about the network from and to endpoints in the network. Controller 104 is associated with one or more virtual and/or physical CPUs (not shown). Processor(s) resources allotted or assigned to controller 104 may be unique to controller 104, or may be shared with other components of the data center. Controller 104 communicates with hosts 110 via management network 180, such as through control plane protocols. In some embodiments, controller 104 implements a central control plane (CCP).

Network manager 106 and virtualization manager 108 generally represent components of a management plane comprising one or more computing devices responsible for receiving logical network configuration inputs, such as from a user or network administrator, defining one or more endpoints and the connections between the endpoints, as well as rules governing communications between various endpoints.

In some embodiments, virtualization manager 108 is a computer program that executes in a central server in the data center (e.g., the same or a different server than the server on which network manager 106 executes), or alternatively, virtualization manager 108 runs in one of VMs 112. Virtualization manager 108 is configured to carry out administrative tasks for data center 102, including managing hosts 110, managing VMs running within each host 110, provisioning VMs, transferring VMs from one host 110 to another host 110, transferring VMs between data centers 102, transferring application instances between VMs or between hosts 110, and load balancing among hosts 110 within data center 102. Virtualization manager 108 takes commands as to creation, migration, and deletion decisions of VMs and application instances on the data center. However, virtualization manager 108 also makes independent decisions on management of local VMs and application instances, such as placement of VMs and application instances between hosts 110. In some embodiments, virtualization manager 108 also includes a migration component that performs migration of VMs between hosts 110, such as by live migration.

In some embodiments, network manager 106 is a computer program that executes in a central server in networking environment 100, or alternatively, network manager 106 may run in a VM 112, e.g., in one of hosts 110. Network manager 106 communicates with host(s) 110 via management network 180. Network manager 106 may receive network configuration input from a user or an administrator and generate desired state data that specifies how a logical network should be implemented in the physical infrastructure of the data center. Further, in certain embodiments, network manager 106 may receive security configuration input (e.g., security policy information) from a user or an administrator and configure hosts 110 and ESG 122 according to this input. As described in more detail below, policies configured at hosts 110 and ESG 122 may indicate what action is to be taken when a file is determined to be BENIGN or MALICIOUS.

Network manager 106 is configured to receive inputs from an administrator or other entity, e.g., via a web interface or application programming interface (API), and carry out administrative tasks for the data center, including centralized network management and providing an aggregated system view for a user.

In certain embodiments, a security analyzer 132 may be implemented as an additional component of the management plane. Security analyzer 132 may maintain a database 136 of verdicts for files inspected by hosts 110 and/or ESG 122. In certain embodiments, database 136 stores file hashes and associated verdicts produced by one or more hosts 110 and/or ESG 122 for each of the files inspected. It should be noted that different embodiments may implement different data structures for maintaining file hashes and associated verdicts, and that any suitable data structure(s) may be used, including other tables, arrays, bitmaps, hash maps, etc.

Security analyzer 132 may also maintain in its database 136, verdicts produced by other trusted sources, which may be stored in any suitable data structure(s). Examples of other trusted sources that are implemented to inspect files and provide verdicts for such files include Lastline cloud services 154 and Carbon Black cloud services 156 made commercially available from VMware, Inc. of Palo Alto, California. Lastline cloud services 154 and Carbon Black cloud services 156 provide security software that is designed to detect malicious behavior and help prevent malicious files from attacking an organization. Though certain aspects are described with respect to Lastline cloud services 154 and Carbon Black cloud services 156, any similar dynamic analyzer may be used according to the techniques discussed herein. In particular, Lastline cloud services 154 and Carbon Black cloud services 156 may be implemented to perform dynamic analysis of files. Dynamic analysis monitors the actions of a file when the file is being executed. Dynamic analysis may also be referred to as behavior analysis because the overall behavior of the sample is captured in the execution phase. Lastline cloud services 154 and Carbon Black cloud services 156 may perform dynamic analysis in a “sandbox”, or in other words, an isolated environment, to ensure that components of data center 102 are not affected in cases where the file executed for analysis contains malware (e.g., is a MALICIOUS file).

Such files may be analyzed by Lastline cloud services 154 and Carbon Black cloud services 156 where static analyzer 120, 126 determines additional analysis is desired. For example, static analyzer 120, 126 may perform static analysis and return a verdict of BENIGN for a file; however, a confidence level associated with the BENIGN verdict produced by static analyzer 120, 126 may be below a threshold confidence level; thus, to ensure the file is BENIGN, static analyzer 120, 126 may determine dynamic analysis is warranted by Lastline cloud services 154 and/or Carbon Black cloud services 156. Accordingly, Lastline cloud services 154 and/or Carbon Black cloud services 156 may perform dynamic analysis for the file to produce a verdict for the file. The verdict produced by Lastline cloud services 154 and/or Carbon Black cloud services 156 may take precedence over a verdict produced by static analyzer 120 on host 110 or static analyzer 126 on ESG 122 for the same file (e.g., where the verdicts are different). In this case, only the verdicts produced by Lastline cloud services 154 and Carbon Black cloud services 156 may be stored in database 158 on private cloud 152, as well as in database 136 and ASDS caches 150, 128 of hosts 110 and ESG 122, respectively.

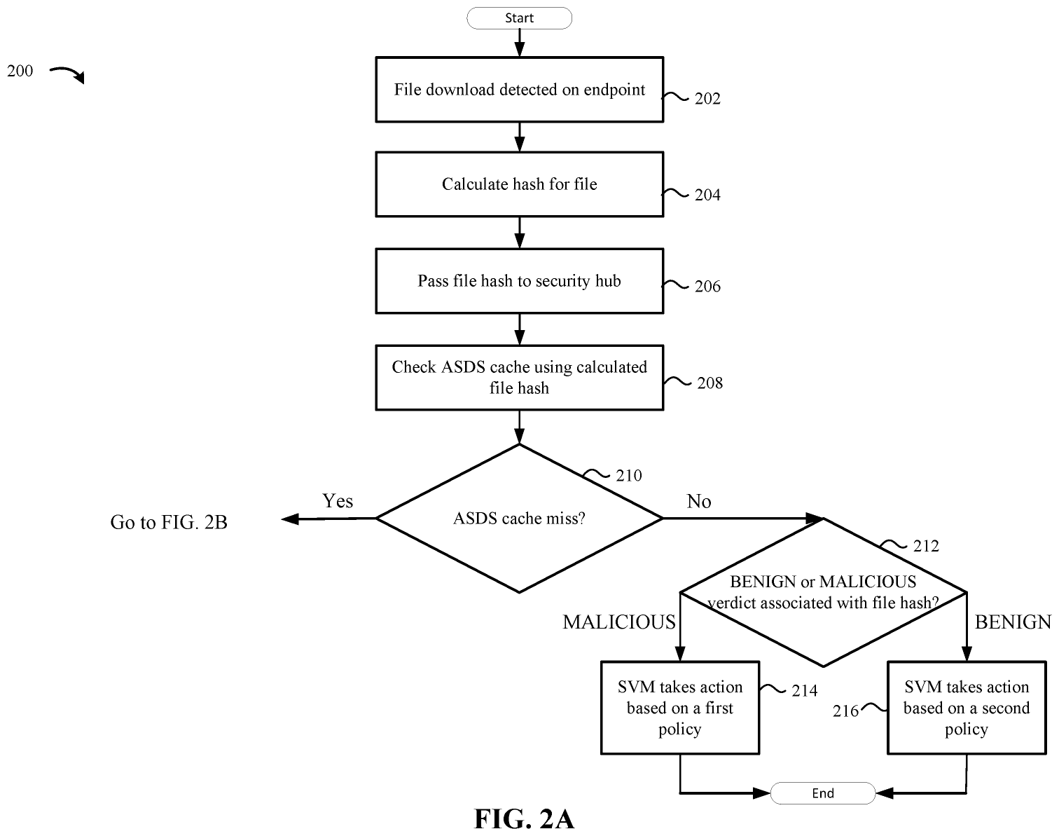

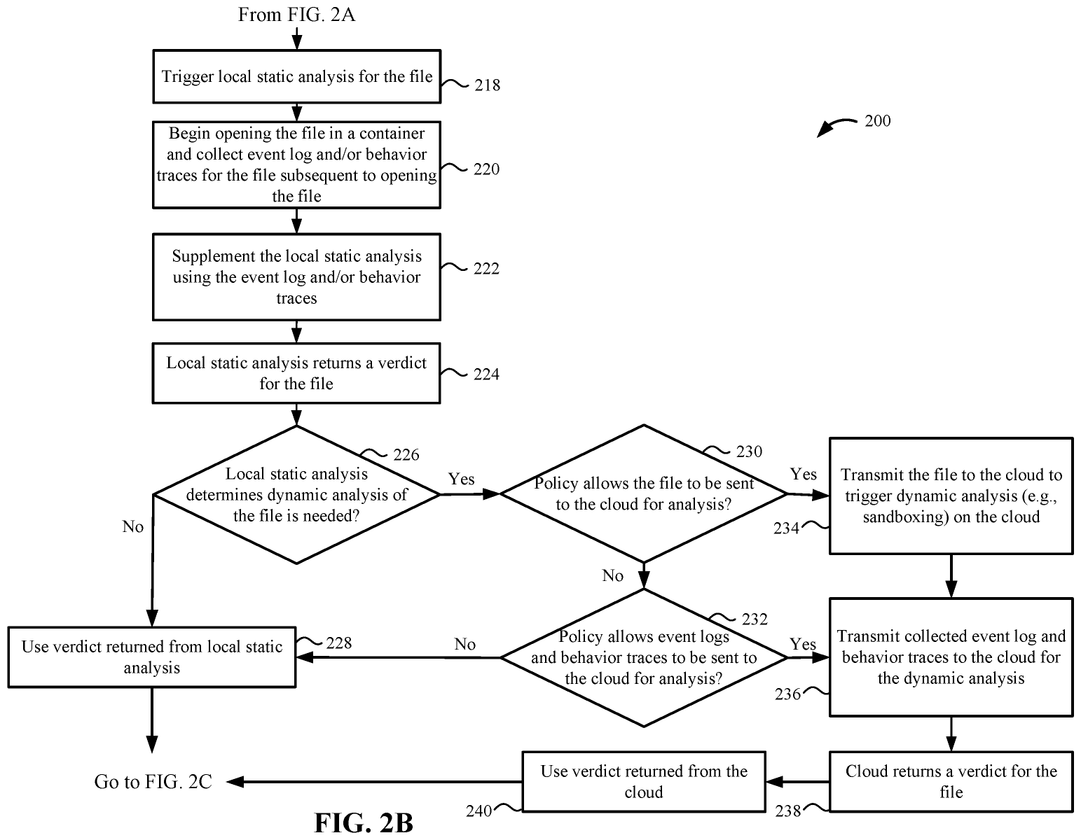

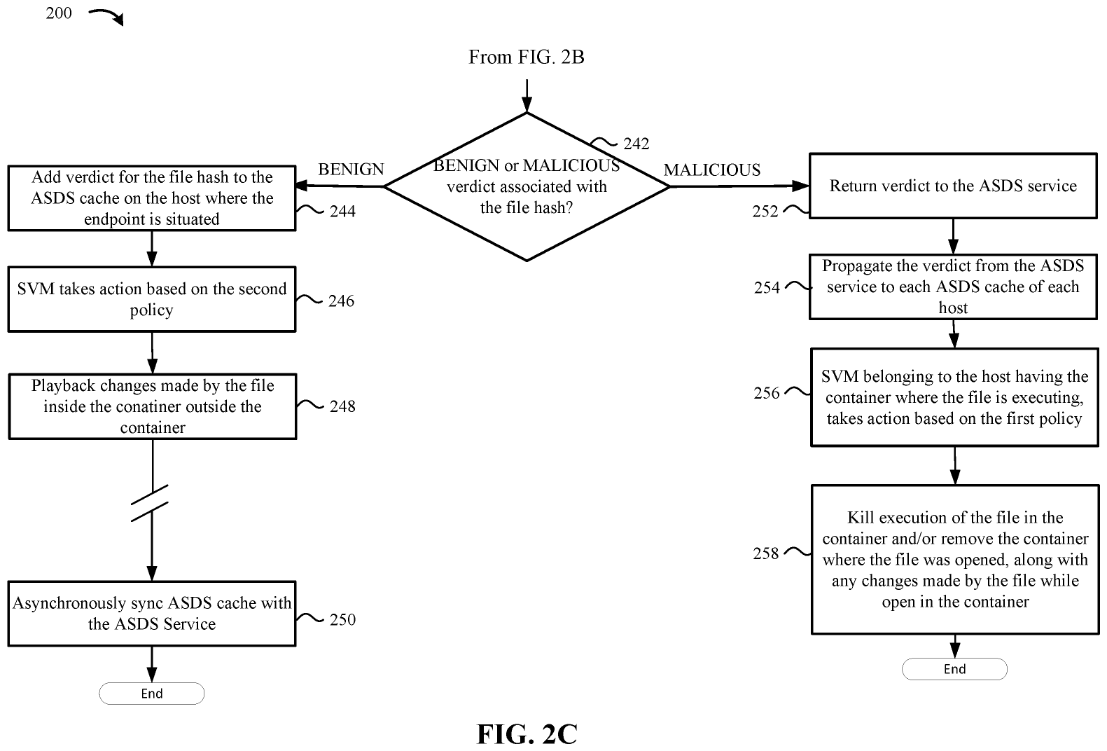

FIGS. 2A, 2B, and 2C illustrate an example workflow 200 for evaluating unknown files in a distributed malware detection system, according to an example embodiment of the present application. Workflow 200 of FIG. 2 may be performed, for example, by components of networking environment 100 illustrated in FIG. 1.

Workflow 200 may be used to identify, generate, and/or report verdicts for files at one or more endpoints in a networking environment configured with distributed anti-malware capability. As used herein, an endpoint may be any device, such as host 110, ESG 122, etc. illustrated in FIG. 1. Further, workflow 200 may be used to identify a file with an unknown verdict, trigger malware analysis for the file, and allow for action under a policy while the file is being analyzed. As described previously, to ensure optimal user experience, the policy implemented while the file is being analyzed may allow a user to access and/or execute the file in a container, such as container 160 illustrated in FIG. 1, as opposed to quarantining the file until a verdict is published. The policy may allow for access and/or execution of the file in container 160 although it is unknown whether the file is safe for execution (e.g., unknown whether the file contains malware). Executing the unknown file in container 160 may reduce the risk of one or more endpoints, or one or more VMs 112 running on such endpoints, becoming compromised between the time when the file is allowed to execute to the time when a verdict is returned for the file, where the file is, in fact, MALICIOUS.

Where the verdict returned for the file is MALICIOUS, container 160 where the file was executing may be deleted, and any changes made by the file inside container 160 during execution may not be persisted. Alternatively, where the verdict returned for the file is BENIGN, changes made by the file inside container 160 during execution (e.g., prior to producing a verdict of UNKNOWN for the file) may be persisted outside container 160, for example, in data center 102.

Workflow 200 begins, at operation 202, by an endpoint, such as VM 112 on host 110 or ESG 122 in data center 102 illustrated in FIG. 1, downloading one or more files. The one or more files downloaded on the endpoint may request to be opened at the endpoint. In some other cases (not shown), workflow 200 may begin by a file being added to a host 110 or ESG 122, prior to execution of a file on a host 110 or ESG 122, and/or the like. While the illustrated example assumes only one file is downloaded at the endpoint, in some other cases, multiple files may be downloaded at the endpoint and each file analyzed using workflow 200. The endpoint downloading the file may be referred to herein as the initiator endpoint given a file download initiates workflow 200 for malware detection. At operation 204, a hash is calculated for the downloaded file. In particular, for each file, a corresponding unique hash of the file may be generated, for example by using a cryptographic hashing algorithm such as the SHA-1 algorithm.

Where the file is downloaded on VM 112 on host 110, a thin agent on VM 112, for example, thin agent 166 illustrated in FIG. 1, may be configured to intercept the file and transfer a hash calculated for the file to a multiplexer, such as multiplexer 116 illustrated in FIG. 1. Accordingly, multiplexer 116, at operation 206, passes the calculated hash to a security hub, such as security hub 118 illustrated in FIG. 1. Alternatively, where the file is downloaded on ESG 122, a plugin may be used to intercept the file and, at operation 206, pass a calculated hash for the file to a security hub.

The security hub may be a security hub implemented at the initiator endpoint or another endpoint (e.g., in cases where the initiator endpoint is not configured with a security hub). For example, the security hub may be security hub 118 implemented on host 110 as illustrated in FIG. 1 when the initiator endpoint is (1) a VM 112 on host 110 where security hub 118 is implemented or (2) a VM 112 on host 110 where security hub 118 is not implemented. In some other examples, the security hub may be security hub 124 implemented on ESG 122 as illustrated in FIG. 1, such as when the initiator endpoint is ESG 122. Accordingly, though certain processes described herein for retrieving verdicts, performing static and/or dynamic analysis, locating MALICIOUS files, etc., are described as occurring at the initiator endpoint, they may instead occur at a different endpoint.

As mentioned, security hubs 118, 124 may be configured to retrieve verdicts for known files (files known to be BENIGN or MALICIOUS based on prior inspection for malware content) from a cache at the initiator or other endpoint storing hash values and verdicts for previously inspected files. For example, the cache may be ASDS cache 150 at host 110 illustrated in FIG. 1 when the initiator or other endpoint is a VM 112 on host 110. In some other examples, the cache may be ASDS cache 128 at ESG 122 illustrated in FIG. 1 when the endpoint is ESG 122.

ASDS caches 150, 128 may store verdicts (and associated security attributes) for files (e.g., each identified by a unique hash value) that have been returned or published to endpoints in the environment. For example, a BENIGN file verdict for a file may have been prior returned to an initiator endpoint in data center 102 (e.g., and stored in its ASDS cache) when the file was previously determined to be safe after performing static and/or dynamic analysis for the file. In this case, the BENIGN file verdict may have been previously returned to the initiator endpoint. The BENIGN file verdict may also be present in ASDS caches of other endpoints where the BENIGN verdict from the initiator endpoint was previously synchronized with an ASDS service, such as ASDS service 134 on security analyzer 132 illustrated in FIG. 1, and published from ASDS service 134 to other endpoints in data center 102 (e.g., and stored by each endpoint in their respective ASDS cache). As used herein, publishing verdicts to endpoints in data center 102 may include (1) broadcasting to all endpoints in data center 102, (2) synchronizing local ASDS caches of each endpoint with ASDS service 134 such that the verdict is provided to each local ADS cache, and/or (3) inserting the verdict into a central repository, such as database 136, to allow for an endpoint to retrieve the verdict for a file (e.g., when a cache miss occurs which is described in more detail below).

Also, a MALICIOUS file verdict for a file may have been previously published to endpoints in data center 102 (e.g., and stored in their respective ASDS caches) where the file was previously determined to be unsafe after performing static and/or dynamic analysis for the file. In this case, after determining the file exhibits MALICIOUS behavior, a MALICIOUS verdict for the file may have been provided to ASDS service 134 and published from ASDS service 134 to other endpoints in data center 102 (e.g., and stored by each endpoint in their respective ASDS cache). In certain aspects, a BENIGN verdict may only be published at a later time to all endpoints in data center 102, while MALICIOUS verdicts may be immediately published to all endpoints in data center 102, such that MALICIOUS files may be identified and immediately removed, to avoid the risk of such MALICIOUS files causing additional damage to components in data center 102.

ASDS caches 150, 128 make verdicts for previously inspected files readily available such that requests for a file verdict are returned faster than having to access the endpoint's primary storage location. In other words, ASDS caches 150, 128 allow endpoints to efficiently reuse previously determined and published verdicts for files inspected in the environment.

Accordingly, at operation 208, security hub 118 or security hub 124 uses the calculated file hash to search ASDS cache 150 or ASDS cache 128 at the endpoint where security hub 118 or security hub 124 is implemented. Where at operation 210 the hash value is located in the cache (e.g., no cache miss), at operation 212, the verdict associated and stored with the hash value is retrieved. In cases where the endpoint retrieving the verdict is not the initiator endpoint, the retrieved verdict may be returned to the initiator endpoint to take appropriate action with respect to the file.

As mentioned, verdicts stored in the cache may be either BENIGN or MALICIOUS verdicts. Accordingly, where a MALICIOUS verdict is stored for the file hash, at operation 214, the initiator endpoint (e.g., in some cases, via an SVM on the initiator endpoint, such as SVM 113 illustrated in FIG. 1) may take a first policy action. The first policy action may be determined based on policies configured for endpoints in the environment at network manager 106. For example, the initiator endpoint may be configured to reset a connection, quarantine the file, delete/exterminate the file, not allow the file to run, and/or the like, where a MALICIOUS verdict is returned for the file hash. Similarly, where a BENIGN verdict is stored for the file hash, at operation 216, the initiator endpoint (e.g., in some cases, via SVM 113 on the initiator endpoint) may take a second policy action. The second policy action may be determined based on policies configured for endpoints in the environment at network manager 106. For example, the initiator endpoint may be configured to allow a file download, the opening of a file, the execution of a file, and/or the like, where a BENIGN verdict is returned for the file hash.

Alternatively, if the file hash for the file is not located in the cache (e.g., ASDS cache 150 or ASDS cache 128), the file may be considered to be an unknown file, or in other words the file is classified as an unknown file. In particular, the file is considered to be unknown because the file has not previously been inspected (e.g., no static and/or dynamic analysis of the file has previously been performed) to be classified as either BENIGN or MALICIOUS. Accordingly, a verdict for the file does not exist in the cache thereby making the file “unknown”.

If, at operation 210 (e.g., illustrated in FIG. 2B), the requested file hash is not found in the cache, in other words a cache miss occurs, then at operation 218, security hub 118 or 124 may select the unknown file for static analysis and trigger initiation of the static analysis. More specifically, in certain aspects, security hub 118, 124 may pass the file (and its associated hash) to a static analyzer (e.g., such as static analyzer 120 at host 110 or static analyzer 126 at ESG 122 illustrated in FIG. 1) to perform static analysis on the unknown file.

At operation 220, a user attempting to open (e.g., execute, access, etc.) the file having the unknown verdict may be permitted to open the file in a container, such as container 160 illustrated in FIG. 1. The user may be allowed to open the file at the same time as, or subsequent (e.g., immediately after or a period of time after) to, triggering static analysis for the file at operation 218 (and prior to receiving a verdict for the file). In certain aspects, opening the file may initiate the collection of events in an event log maintained for the file. In certain aspects, opening the file may initiate the monitoring of behavior of the file (e.g., during execution) to be recorded as behavior traces for the file. The event log and/or behavior traces recorded for the file may be maintained in container 160, in certain aspects.

At operation 222, the collected event log and/or behavior traces for the file may be used to supplement the static analysis of the unknown file. For example, the event log and/or behavior traces for the file may be transmitted to the static analyzer (e.g., static analyzer 120 at host 110 or static analyzer 126 at ESG 122 illustrated in FIG. 1) performing static analysis for the file. In certain aspects, the static analyzer may perform static analysis for the file by analyzing the file, a received event log associated with the file, and/or received behavior traces for the file to produce a verdict for the file. The event log and/or behavior traces for the file may be transmitted to the static analyzer continuously, periodically, at fixed intervals, etc. as new information is collected for the file while the file is open in container 160.

At operation 224, the static analyzer, performing local static analysis, returns a verdict for the file based on analyzing the file, a received event log associated with the file, and/or received behavior traces for the file. The verdict returned for the file may be either BENIGN or MALICIOUS.

In certain aspects, the static analyzer may determine whether further analysis, for example, dynamic analysis, of the file is warranted. The static analyzer may make this determination based on one or more factors including a confidence level of the static analyzer in identifying that the file is safe or unsafe. For example, where the static analyzer returns a verdict of BENIGN but has a confidence level of 30% (e.g., below a threshold) that the file is BENIGN, the static analyzer may determine further analysis of the file is needed before concluding that the file is safe for execution outside container 160. On the other hand, where the static analyzer returns a verdict of BENIGN and has a confidence level of 90% (e.g., above the threshold) that the file is BENIGN, the static analyzer may determine further analysis of the file is not needed and characterize the file as BENIGN.

Accordingly, where at operation 226, the static analyzer determines dynamic analysis for the file is not needed, at operation 228, the verdict returned by the static analyzer may be used to classify the file. As described in more detail with respect to FIG. 2C, the returned verdict may indicate to an initiator endpoint what policy action to take.

Alternatively, where at operation 226, the static analyzer determines dynamic analysis for the file is desired, at operation 230, a policy may be checked to determine whether the file is permitted to be sent to the cloud for further analysis. In certain aspects, customers (e.g., a user or administrator) may configure a policy which does not allow the file itself to be transmitted to outside sources for analysis (e.g., for security of sensitive information contained by such files). Alternatively, where a policy is configured which allows for the file to be transmitted to outside sources for analysis (or a restrictive policy for the file is not configured), the file itself, may be transmitted to outside sources, such as Lastline cloud services 154 and Carbon Black cloud services 156. Lastline cloud services 154 and Carbon Black cloud services 156 provide security software that is designed to perform dynamic analysis, and more specifically, monitor the actions of a file when the file is being executed for purposes of detecting malicious behavior of the file.

Where, at operation 230, a configured policy allows for the file to be sent to the cloud for dynamic analysis (or no restrictive policy exists), at operation 234, the file is transmitted to the cloud (e.g., to Lastline cloud services 154 and/or Carbon Black cloud services 156) to trigger dynamic analysis (e.g., sandboxing) of the file on the cloud. Further, at operation 236, an event log and/or behavior traces collected for the file (e.g., beginning at operation 220) are transmitted to the cloud to supplement the dynamic analysis of the file. The event log and/or behavior traces collected for the file may be transmitted to the cloud continuously, periodically, at fixed intervals, etc. as new information is collected for the file while the file is open in container 160.

At operation 238, trusted source(s) at the cloud return a verdict for the file. The verdict returned for the file by trusted source(s) may take precedence over a verdict produced by the static analyzer, at operation 224, for the same file (e.g., where the verdicts are different). Accordingly, at operation 240, the verdict returned by the trusted source(s) at the cloud may be used to classify the file. As described in more detail with respect to FIG. 2C, the returned verdict may indicate to an initiator endpoint what policy action to take.

Returning to operation 230, where a configured policy does not allow for the file itself to be sent to the cloud for dynamic analysis, the file may not be transmitted to the cloud. However, at operation 232, a policy may be checked to determine whether the event log and/or behavior traces collected for the file is permitted to be sent to the cloud for dynamic analysis. In certain aspects, customers (e.g., a user or administrator) may configure a policy which does not allow the file, as well as its event log and behavior traces, to be transmitted to outside sources for analysis (e.g., for security of sensitive information contained by the event log and/or behavior traces for the file). Alternatively, where a policy is configured which allows for the event log and/or behavior traces to be transmitted to outside sources for analysis (or a restrictive policy for the file is not configured), the event log and/or behavior traces, may be transmitted to outside sources, such as Lastline cloud services 154 and Carbon Black cloud services 156. Lastline cloud services 154 and Carbon Black cloud services 156 may use the event log and/or behavior traces for the file to perform dynamic analysis for purposes of determining whether the file exhibits malicious behavior.

Accordingly, where, at operation 232, a configured policy allows for the event log and/or behavior traces associated with the file to be sent to the cloud for dynamic analysis (or no restrictive policy exists), at operation 236, the event log and/or behavior traces collected for the file (e.g., beginning at operation 220) are transmitted to the cloud such that dynamic analysis of the file may be performed using this information collected for the file. The event log and/or behavior traces collected for the file may be transmitted to the cloud continuously, periodically, at fixed intervals, etc. as new information is collected for the file while the file is open in container 160.

At operation 238, trusted source(s) at the cloud return a verdict for the file (e.g., based on the event log and/or behavior traces, and not the file itself, transmitted to the cloud). The verdict returned for the file by trusted source(s) may take precedence over a verdict produced by the static analyzer, at operation 224, for the same file (e.g., where the verdicts are different). Accordingly, at operation 240, the verdict returned by the trusted source(s) at the cloud may be used to classify the file. As described in more detail with respect to FIG. 2C, the returned verdict may indicate to an initiator endpoint what policy action to take.

Returning to operation 232, where a configured policy does not allow for the event log and/or behavior traces collected for the file to be sent to the cloud for dynamic analysis, the event log and/or behavior traces for the file may not be transmitted to the cloud. Thus, dynamic analysis of the file may not be performed, and at operation 228, the verdict returned by the static analyzer may be used to classify the file. As described in more detail with respect to FIG. 2C, the returned verdict may indicate to an initiator endpoint what policy action to take.

Although FIG. 2B illustrates static analysis being performed for the file, in certain other aspects, security hub 118, 124 may be triggered to pass the file (and its associated hash) to cloud trusted sources, such as Lastline cloud services 154 and/or Carbon Black cloud services 156, to perform dynamic analysis on the unknown file, without first sending the file to static analyzer 120, 126.

Where at operation 242 (e.g., as shown in FIG. 2C), the verdict determined (e.g., at operation 228 or operation 240) to be used for the file is BENIGN, at operation 244, the verdict for the file is added to the ASDS cache on the endpoint where the file was downloaded (e.g., at operation 202 in FIG. 2A), such as ASDS cache 150 on host 110 or ASDS cache 128 on ESG 122. As mentioned previously, a BENIGN file verdict for a file may be returned to an initiator endpoint in data center 102 (e.g., and stored in its ASDS cache) where the file is determined to be safe after performing static and/or dynamic analysis(es) for the file. In certain aspects, in contrast, a MALICIOUS file verdict may be published to all endpoints in data center 102 (e.g., and stored in their respective ASDS caches) when the file is determined to be unsafe after performing static and/or dynamic analysis for the file.

At operation 246, the initiator endpoint (e.g., in some cases, via SVM 113 on the initiator endpoint) may take a second policy action. The second policy action may be determined based on policies configured for endpoints in the environment at network manager 106. For example, the initiator endpoint may be configured to continue to allow the file to be downloaded, to be opened, to execute, and/or the like, given a BENIGN verdict is returned for the file hash associated with the file.

At operation 248, operations performed by the file while opened inside container 160 prior to returning a verdict for the file, may be persisted outside container 160. In other words, changes made inside the container may be played back, or reproduced, outside the container 160 and in data center 102. For example, where the file modified a file while executing inside container 160, this modification may be persisted outside container 160 when the verdict returned for the file is BENIGN.

At a later time, at operation 250, ASDS cache 150, 128 containing the BENIGN verdict for the previously-unknown file is synchronized with ASDS service 134 of security analyzer 132 to add the BENIGN verdict for the file to database 136. The BENIGN file verdict added to database 136 may be further published to other endpoints in data center 102 so that each endpoint in data center 102 may add the BENIGN file verdict to their corresponding ASDS cache 150, 128. Recording the BENIGN file verdict in each ADS cache 150, 128 of each endpoint may allow for the verdict for the file to be located where the same file is subsequently downloaded.

Returning back to operation 242, where at operation 242 the verdict returned for the file is MALICIOUS, at operation 252 and operation 254, the MALICIOUS verdict for the file is provided to ASDS service 134 and published from ASDS service 134 to other endpoints in data center 102 (e.g., and stored by each endpoint in their respective ASDS cache 150, 128). The MALICIOUS file verdict is also added to database 136 at security analyzer 132. In certain aspects, MALICIOUS verdicts are immediately published to all endpoints in data center 102, such that MALICIOUS files may be identified and immediately removed, to avoid the risk of such MALICIOUS files causing additional damage to components in data center 102.

At operation 256, in response to receiving the MALICIOUS verdict associated with the file (e.g., based on its file hash), SVM 113 on the host 110 where the file was downloaded may take action based on the first policy configured for endpoints in the in data center 102 at network manager 106. For example, as mentioned previously, host 110, via SVM 113, may reset a connection, quarantine the file, delete/exterminate the file, not allow the file to run, and/or the like, where the MALICIOUS verdict is returned. Further, at operation 258, execution of the file running in the container may be killed (e.g., stopped) and/or the container may be removed, along with any changes made by the unknown file while executing in the container.

The various embodiments described herein may employ various computer-implemented operations involving data stored in computer systems. For example, these operations may require physical manipulation of physical quantities usually, though not necessarily, these quantities may take the form of electrical or magnetic signals where they, or representations of them, are capable of being stored, transferred, combined, compared, or otherwise manipulated. Further, such manipulations are often referred to in terms, such as producing, identifying, determining, or comparing. Any operations described herein that form part of one or more embodiments may be useful machine operations. In addition, one or more embodiments also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments may be implemented as one or more computer programs or as one or more computer program modules embodied in one or more computer readable media. The term computer readable medium refers to any data storage device that can store data which can thereafter be input to a computer system computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), NVMe storage, Persistent Memory storage, a CD (Compact Discs), CD-ROM, a CD-R, or a CD-RW, a DVD (Digital Versatile Disc), a magnetic tape, and other optical and non-optical data storage devices. The computer readable medium can be a non-transitory computer readable medium. The computer readable medium can also be distributed over a network coupled computer system so that the computer readable code is stored and executed in a distributed fashion. In particular, one or more embodiments may be implemented as a non-transitory computer readable medium comprising instructions that, when executed by one or more processors of a computing system, cause the computing system to perform a method, as described herein.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system—level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Finally, boundaries between various components, operations and datastores are somewhat arbitrary, and particular operations are illustrated in the context of specific illustrative configurations. Other allocations of functionality are envisioned and may fall within the scope of one or more embodiments. In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s). In the claims, elements and/or steps do not imply any particular order of operation, unless explicitly stated in the claims.

We claim:

1. A method for opening unknown files in a malware detection system, the method comprising:
receiving, at a first endpoint, a request to open a file classified as an unknown file on the first endpoint;
in response to receiving the request, opening the file in a container prior to determining whether the file is benign or malicious;
collecting at least one of a log of events carried out by the file while open in the container or behavior traces of the file observed for the file while open in the container;
transmitting, to a file analyzer, at least one of the file, the log of events, or the behavior traces for static analysis;
determining, a final verdict for the file, based on the at least one of the file, the log of events, or the behavior traces, the final verdict indicating the file is benign or malicious, wherein the final verdict for the file is based on the static analysis or dynamic analysis of the file; and
taking one or more actions based on a policy configured for the first endpoint and the final verdict indicating the file is benign or malicious.

2. The method of claim 1, further comprising:
determining the dynamic analysis of the file is not desired, wherein the final verdict for the file is based on the static analysis of the file.

3. The method of claim 1, further comprising:
determining, a first verdict for the file, based on performing the static analysis for the file using at least one of the file, the log of events, or the behavior traces, the first verdict indicating the file is benign or malicious;
determining the dynamic analysis of the file by one or more outside sources is desired; and
determining the file, the log of events, and the behavior traces are not permitted to be transmitted to the one or more outside sources for the dynamic analysis of the file based on a policy configured for the malware detection system, wherein the final verdict for the file is based on the static analysis of the file.

4. The method of claim 1, further comprising:
determining, a first verdict for the file, based on performing the static analysis for the file using at least one of the file, the log of events, or the behavior traces, the first verdict indicating the file is benign or malicious;
determining the dynamic analysis of the file by one or more outside sources is desired;
transmitting at least one of the file, the log of events, or the behavior traces to the one or more outside sources for the dynamic analysis of the file; and
determining, a second verdict for the file, based on performing the dynamic analysis for the file using at least one of the file, the log of events, or the behavior traces, the second verdict indicating the file is benign or malicious, wherein the final verdict for the file comprises the second verdict.

5. The method of claim 4, wherein:
the file is not permitted to be transmitted to the one or more outside sources for the dynamic analysis of the file based on a policy configured for the malware detection system; and
the dynamic analysis for the file is performed using at least one of the log of events or the behavior traces.

6. The method of claim 1, wherein:
the final verdict indicates the file is malicious; and
taking one or more actions based on a policy configured for the first endpoint comprises deleting the container and any changes made by the file while open in the container.

7. The method of claim 1, wherein:
the final verdict indicates the file is benign; and
taking one or more actions based on a policy configured for the first endpoint comprises reproducing any changes made by the file while open in the container outside the container in the malware detection system.

8. A system comprising:
one or more processors; and
at least one memory, the one or more processors and the at least one memory configured to cause the system to:
receive, at a first endpoint, a request to open a file classified as an unknown file on the first endpoint
in response to receiving the request, open the file in a container prior to determining whether the file is benign or malicious;
collect at least one of a log of events carried out by the file while open in the container or behavior traces of the file observed for the file while open in the container;
transmit, to a file analyzer, at least one of the file, the log of events, or the behavior traces for static analysis;
determine, a final verdict for the file, based on the at least one of the file, the log of events, or the behavior traces, the final verdict indicating the file is benign or malicious, wherein the final verdict for the file is based on the static analysis or dynamic analysis of the file; and
take one or more actions based on a policy configured for the first endpoint and the final verdict indicating the file is benign or malicious.

9. The system of claim 8, wherein the one or more processors and the at least one memory are further configured to cause the system to:
determine the dynamic analysis of the file is not desired, wherein the final verdict for the file is based on the static analysis of the file.

10. The system of claim 8, wherein the one or more processors and the at least one memory are further configured to cause the system to:
determine, a first verdict for the file, based on performing the static analysis for the file using at least one of the file, the log of events, or the behavior traces, the first verdict indicating the file is benign or malicious;
determine the dynamic analysis of the file by one or more outside sources is desired; and
determine the file, the log of events, and the behavior traces are not permitted to be transmitted to the one or more outside sources for the dynamic analysis of the file based on a policy configured for the system, wherein the final verdict for the file is based on the static analysis of the file.

11. The system of claim 8, wherein the one or more processors and the at least one memory are further configured to cause the system to:
determine, a first verdict for the file, based on performing the static analysis for the file using at least one of the file, the log of events, or the behavior traces, the first verdict indicating the file is benign or malicious;
determine the dynamic analysis of the file by one or more outside sources is desired;
transmit at least one of the file, the log of events, or the behavior traces to the one or more outside sources for the dynamic analysis of the file; and
determine, a second verdict for the file, based on performing the dynamic analysis for the file using at least one of the file, the log of events, or the behavior traces, the second verdict indicating the file is benign or malicious, wherein the final verdict for the file comprises the second verdict.

12. The system of claim 11, wherein:
the file is not permitted to be transmitted to the one or more outside sources for the dynamic analysis of the file based on a policy configured for the system; and
the dynamic analysis for the file is performed using at least one of the log of events or the behavior traces.

13. The system of claim 8, wherein:
the final verdict indicates the file is malicious; and
the one or more processors and the at least one memory are configured to cause the system to take one or more actions based on a policy configured for the first endpoint by deleting the container and any changes made by the file while open in the container.

14. The system of claim 8, wherein:
the final verdict indicates the file is benign; and
the one or more processors and the at least one memory are configured to cause the system to take one or more actions based on a policy configured for the first endpoint by reproducing any changes made by the file while open in the container outside the container in the system.

15. A non-transitory computer-readable medium comprising instructions that, when executed by one or more processors of a computing system, cause the computing system to perform operations for opening unknown files in a malware detection system, the operations comprising:
receiving, at a first endpoint, a request to open a file classified as an unknown file on the first endpoint;
in response to receiving the request, opening the file in a container prior to determining whether the file is benign or malicious;
collecting at least one of a log of events carried out by the file while open in the container or behavior traces of the file observed for the file while open in the container;
transmitting, to a file analyzer, at least one of the file, the log of events, or the behavior traces for static analysis;
determining, a final verdict for the file, based on the at least one of the file, the log of events, or the behavior traces, the final verdict indicating the file is benign or malicious, wherein the final verdict for the file is based on the static analysis or dynamic analysis of the file; and
taking one or more actions based on a policy configured for the first endpoint and the final verdict indicating the file is benign or malicious.

16. The non-transitory computer-readable medium of claim 15, wherein the operations further comprise:
determining the dynamic analysis of the file is not desired, wherein the final verdict for the file is based on the static analysis of the file.

17. The non-transitory computer-readable medium of claim 15, wherein the operations further comprise:
determining, a first verdict for the file, based on performing the static analysis for the file using at least one of the file, the log of events, or the behavior traces, the first verdict indicating the file is benign or malicious;
determining the dynamic analysis of the file by one or more outside sources is desired; and
determining the file, the log of events, and the behavior traces are not permitted to be transmitted to the one or more outside sources for the dynamic analysis of the file based on a policy configured for the malware detection system, wherein the final verdict for the file is based on the static analysis of the file.

18. The non-transitory computer-readable medium of claim 15, wherein the operations further comprise:
determining, a first verdict for the file, based on performing the static analysis for the file using at least one of the file, the log of events, or the behavior traces, the first verdict indicating the file is benign or malicious;
determining the dynamic analysis of the file by one or more outside sources is desired;
transmitting at least one of the file, the log of events, or the behavior traces to the one or more outside sources for the dynamic analysis of the file; and
determining, a second verdict for the file, based on performing the dynamic analysis for the file using at least one of the file, the log of events, or the behavior traces, the second verdict indicating the file is benign or malicious, wherein the final verdict for the file comprises the second verdict.

19. The non-transitory computer-readable medium of claim 18, wherein:
the file is not permitted to be transmitted to the one or more outside sources for the dynamic analysis of the file based on a policy configured for the malware detection system; and
the dynamic analysis for the file is performed using at least one of the log of events or the behavior traces.

20. The non-transitory computer-readable medium of claim 15, wherein:
the final verdict indicates the file is malicious; and
taking one or more actions based on a policy configured for the first endpoint comprises deleting the container and any changes made by the file while open in the container.
